(19) United States
(12) Patent Application Publication
(10) Pub. No.: US 2010/0035048 A1
(43) Pub. Date: Feb. 11, 2010

(54) METHOD OF INSTALLING FILM SHEET STRUCTURE AND ASSEMBLIES AND KITS MADE THEREWITH

(75) Inventor: Robert J. Reuter, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/579,761

(22) Filed: Oct. 15, 2009

Related U.S. Application Data
(62) Division of application No. 11/618,033, filed on Dec. 29, 2006.

(51) Int. Cl. B32B 5/00; B32B 37/00; B32B 38/10

(52) U.S. Cl. 428/332; 156/60; 156/247

(57) ABSTRACT

Methods, apparatus and kits for installing window film sheet structures over transparent panels or the like are provided. The methods, apparatus and kits include frame assemblies in combination with the window films that are easily installed in a do-it-yourself environment so as to avoid damage to the window films.

### CROSS REFERENCE TO RELATED APPLICATIONS

The present application is a divisional of U.S. application Ser. No. 11/618,033, filed Dec. 29, 2006, the entire disclosure being incorporated by reference herein. The present application is related to co-pending and commonly assigned U.S. applications: U.S. application Ser. No. 11/618,001 (Attorney Docket No. 62687US002) entitled “Window Film Assembly And Method of Installing”; U.S. application Ser. No. 11/618,015 (Attorney Docket No. 62688US002) entitled “Window Film Frame Assemblies For Installation Over Windows And Methods”; and U.S. application Ser. No. 11/618,050 (Attorney Docket No. 62690US002) entitled “Apparatus For Mounting Laminates On Substrates And Methods Thereof”; all filed Dec. 29, 2006.

### BACKGROUND

The present invention relates generally to methods, apparatus, and a kit for installing window film structures. More particularly, it relates to methods, apparatus, and a kit for easily and reliably installing window film structures in a manner for avoiding formation of permanent film flaws therein diminishing their optical properties, while at the same time may enhance thermal insulation for associated window assemblies.

Window films are generally transparent plastic and/or metallized laminates applied as a thin layer to transparent panels, such as glass windows. Window films are available in many different compositions for bringing about varying effects on the optical and mechanical properties of the underlying transparent panels. Window films can reduce energy costs by minimizing the amount of heat entering a building through sunlight, thereby decreasing the amount of energy needed to cool the building. Window films also act as a filter for reflecting most ultraviolet and infrared wavelengths while allowing passage of visible light. This can result in substantial reductions in cooling costs. As noted, such films reduce the amount of ultraviolet entering a window, and are also often applied to reduce fading of the contents of a room. Other kinds of thin window films include security films applied to prevent glass from shattering, as well as privacy films for controlling the visible light transmitted for effecting privacy purposes.

It will be appreciated that several factors are considered in selecting the correct film to be installed. Such factors include visible light transmission, properties of solar energy to be reflected, and aesthetic considerations, such as distortion free viewing following installation.

Because window films are usually installed by applying them to either or both surfaces of flat finished glass, the resulting laminates are less costly than buying chemically altered specialty glass for bringing about the same desired solutions. Because window films provide energy savings and help protect furnishings among other advantages, they are generally considered to be an investment that pays for itself. As such, they have gained widespread commercial acceptance.

Unless the window films are properly applied to windows, there is a chance that they will crease and fold, during cutting and installation due to their inherent highly flexible nature. Due to the inherent mechanical and chemical properties of these films, their installation can be tedious and subject to several shortcomings particularly in a do-it-yourself context. Generally window films are thin and may be difficult to handle, especially if large window panels are to be laminated. For example, window films are relatively thin, such as up to 4 mils. These thin films have a tendency to fold upon themselves. Measuring and cutting thin films to the correct size before they are directly applied is particularly difficult, especially if irregular window shapes are involved and installation is performed by non-professionals, such as a do-it-yourself installer. Additionally, most window films are covered by a release sheet that must be removed before application of the film on the window. However, there is a strong tendency for the thin adhesive covered film surface to permanently wrinkle, crumple, or crease as the release sheet is manually removed. Accordingly, these film surfaces may stick to themselves even before the release sheet is completely removed. Creasing, wrinkling, etc. may cause permanent film flaws eventually that lead to discarding the films. Moreover, there is a chance that they will cause permanent flaws in the film which diminish their optical properties. Some of these window films include ultraviolet (UV) blocking materials that may in certain circumstance even damage the underlying window to which they are applied. As such, it is desired to avoid having the UV blocking film contact the window directly.

Also, such window film sheet structures are typically provided with an adhesive layer. The adhesive layer is exposed following removal of a low adhesion release liner and mounted to a window casement or the like. As noted, cutting and installing such thin films tends to be problematic due to their very flexible nature not to mention the adhesive layer sticking to itself in the process. As such, adhesives tend to further limit their uses, especially in do-it-yourself applications.

Attempts have been made to space transparent films incrementally from windows in order to improve the R-value associated with the windows. An R-value is a rating utilized to measure how well insulation can resist heat flow. The higher the R-value, the greater the insulating properties and the slower heat and cold flows through it. Such films provide for reduction in heating costs. However, while window films are beneficial they have not necessarily been successfully adapted for use in thermally insulating transparent panels, such as windows. In part, this is due to the films being very thin, such as in the order of about 1 mil to about 4 mil. Typically, when applied to a frame for mounting the same, they cannot be kept planar over a frame opening. This is due primarily to their very flexible nature (i.e., they cannot sustain their dimensions). Accordingly, physical distortions of the films may arise and their optical properties are compromised. Because these films tend to be heat shrinkable, one typical approach for addressing their very flexible nature is to apply heat locally on the film. This is usually done by a hair dryer, heat gun, or other similar device. Heating causes the film to shrink over the frame opening, whereby it assumes a taught and generally planar orientation. As such, visual distortions thru the film are minimized and the appearance of the film over the window appears aesthetic. However, when heat is applied, it is usually done after the film has been applied to the frame and the film has reached room temperature of its operating environment. In some cases, heat is applied up to 24 hours after the film has been mounted on a frame. Clearly, this additional labor and time inhibit the ability for quick and reliable mounting window film sheet structures to frames in many situations.

Also, direct application of the adhesive layers to window casements or the like inhibits reuse from heating season to heating season since the adhesive qualities tend to diminish through repeated usage. In addition, if window films are directly attached to windows, they are difficult to remove.

Thus, due to the number and complexity of steps involved in installing inherently very flexible film, along with the adhesive issues associated with installing thin window films, the prior approaches are generally considered time consuming, demanding, as well as potentially costly. These burdens are even more pronounced particularly in the do-it-yourself field, wherein a typical installer has very little experience handling these materials. Without the foregoing issues being satisfied, the true potential of successfully using and applying window film sheet structures in a manner that: avoids optical distortions due to their very flexible and adhesive qualities causing permanent film flaws; and, may promote thermal insulation during repeated heating seasons may not be fully achieved, especially in a simple, reliable, less time consuming and less costly manner.

### SUMMARY

The present invention provides enhanced methods, apparatus, methods of making such apparatus, and a kit adapted for making frames adaptable for installing window film structures over transparent panels, such as windows in a manner representing improvements over prior art approaches.

The present invention relates generally to frame assemblies carrying films and, more particularly, to frame assemblies adapted for installing window film structures over windows of window assemblies as well as maintaining their optical properties.

The present invention provides a film frame assembly in combination with a transparent panel assembly defining an opening adjacent a transparent panel. The film frame assembly is adapted for installing window film structures over the transparent panel, the combination comprises: a frame defining a frame opening; one or more pressure-sensitive adhesive portions on at least one side of the frame and being attachable to the transparent panel assembly; and a generally flexible film sheet structure for covering the frame opening, wherein the frame comprising a plurality of frame elements, each one having a channel that is aligned with channels of the other frame elements to thereby define a receptacle for removably receiving the film sheet structure.

The present invention provides a method of making a transparent panel film frame assembly adapted for installing window film structures over a transparent panel in a transparent panel assembly, the method comprising: providing a film sheet structure; providing a frame defining a frame opening, wherein the frame provided includes a plurality of frame elements, each one having a channel; aligning the channels of the frame elements to thereby define a receptacle for removably receiving the film sheet structure; applying one or more pressure-sensitive adhesive portions to at least one side of each of the frame elements so that the frame elements can be connected to the transparent panel assembly; and inserting the film sheet structure within the receptacle.

The present invention provides a kit that comprises: a frame defining a frame opening, wherein the frame includes a plurality of frame elements, each one having a channel that is aligned with channels of the other frame elements to thereby define a receptacle for removably receiving the film sheet structure; one or more pressure-sensitive adhesive portions on at least one side of the frame elements; and a generally planar film sheet structure for covering a frame opening, wherein the film sheet structure is generally stiff and remains generally planar when inserted in the receptacle.

The present invention provides a film frame assembly in combination with a transparent panel assembly including a transparent panel, the film frame assembly is adapted for installing window film structures over the transparent panel, the combination comprises: a transparent panel film sheet structure, a frame defining a frame opening, wherein the frame includes a plurality of frame elements, each one having pressure-sensitive adhesive portions attached to one surface for adhesively securing the frame elements to the transparent panel, and each one having pressure-sensitive adhesive portions on an opposing surface for adhesively securing the transparent panel film sheet structure thereto, whereby the transparent panel film sheet structure may provide for thermal insulation and is spaced apart from the transparent panel.

The present invention provides a method of installing a film sheet structure in a spaced apart relationship from a transparent panel, the method comprises: providing a frame that includes a plurality of frame elements for defining a frame opening; providing a film sheet structure that is sized to cover the frame opening; adhesively securing one side of each of the frame elements to the transparent panel; and adhesively securing another side of each of the frame elements to the film sheet structure so that the film sheet structure is spaced apart and may have a thermal insulating relationship to the transparent panel.

The present invention a kit that comprises: a window film sheet structure; a frame defining a frame opening, wherein the frame includes a plurality of frame elements; a plurality of pressure-sensitive adhesive portions attachable for adhesively securing the frame elements to the window, and for adhesively securing the window film sheet structure to the frame elements.

An aspect of the invention is the provision of method, apparatus, and kit for providing a modular frame assembly using a window film sheet structure adapted for installing window film structures over a window assembly.

An aspect of the present invention is a method, apparatus, and kit adaptable to use window film sheet structures for installing window film structures over windows as well as maintaining optical properties of the window film sheet structures.

An aspect of the present invention is a method, apparatus, and kit that achieve the foregoing in a manner that minimizes significantly the costs and labor associated with making such modular frame structures perform as noted.

Another aspect of the present invention is a method, apparatus, and kit that achieve the foregoing in a manner that increases significantly the reliability and ease of installing, such as window film sheet structures particularly in a do-it-yourself environment.

An aspect of the present invention is a method, apparatus, and kit that achieve the foregoing in a manner that obtains the benefits of installing window film structures over window film assemblies by using window film sheet structures that do not require adhesives.

The aspects described herein are merely a few of the several that can be achieved by using the present invention. The foregoing descriptions thereof do not suggest that the invention must only be utilized in a specific manner to attain the foregoing aspects.

These and other features and aspects of one aspect of this invention will be more fully understood from the following detailed descriptions of the preferred embodiments. It should be understood that the foregoing generalized descriptions and the following detailed descriptions are exemplary and are not restrictive of the invention.

### BRIEF DESCRIPTION OF THE DRAWINGS

FIG. 1A is a schematic view of one aspect of method of forming a modular frame assembly usable in mounting a window film sheet structure in spaced apart relationship to an underlying window of a window assembly.

FIG. 1B is a schematic view illustrating mounting the vertical frame elements on a window assembly.

FIG. 2A is a schematic view of measuring and cutting horizontal frame elements of the modular frame assembly.

FIG. 2B is a schematic view illustrating mounting the horizontal frame elements on a window assembly.

FIG. 2C is a schematic cross-sectional view of each of the frame elements.

FIG. 3A is a schematic view illustrating measuring a window film sheet structure placed over the modular film frame assembly.

FIG. 3B is a schematic view illustrating cutting the window film sheet structure shown in FIG. 3A.

FIG. 4 is a schematic view illustrating insertion of the window film sheet structure into a film retaining receptacle formed by the modular film frame assembly.

FIG. 5 is a schematic view illustrating mounting a top horizontal frame piece on the modular film frame assembly.

FIG. 6 is a schematic view illustrating applying finishing corners to modular film frame assembly.

FIG. 7 is a schematic view illustrating a finished modular film frame assembly having a window film sheet structure mounted in combination with a window assembly.

FIG. 8 is an enlarged cross-sectional view of a window film sheet structure usable in this invention.

FIG. 9 is a schematic view of one aspect of a method of forming a template for sizing and shaping a window film sheet structure.

FIG. 10 is a schematic view of a template mounted on a window.

FIG. 11 is a schematic view of mounting a window film sheet structure over the film mounting tool apparatus of FIG. 10.

FIG. 12 is a schematic view of the window film sheet structure being cut.

FIG. 13 is a schematic view of removal of the template from the window film sheet structure.

FIG. 14A is a schematic view of horizontal spacer elements being measured and cut to fit an opening of a window assembly.

FIG. 14B is a schematic view of vertical spacer elements being measured and cut to fit a window assembly, as well as the horizontal spacer elements being installed.

FIG. 14C is a schematic view illustrating a spacer element according to this invention in spaced relationship with a window and a window film sheet structure.

FIG. 15 is a schematic view of another aspect of a method of this invention wherein release liners are removed and the spacer elements are mounted on the window assembly.

FIG. 16 is a schematic view illustrating mounting the window film sheet structure to the mounted spacer elements.

FIG. 17 is a schematic view illustrating application of wood grain trim strips to the mounted window film structure.

FIG. 18 is a schematic view of a finished film frame assembly made according to this invention.

### DETAILED DESCRIPTION

The words “a”, “an”, and “the” are utilized interchangeably with “at least one” to mean one or more of the elements being described. By using words of orientation, such as “top”, “bottom”, “overlying”, “front”, “back” and “backing” and the like for the location of various elements in the disclosed articles, we refer to the relative position of an element with respect to a horizontally-disposed body portion. It is not intended that the disclosed articles should have any particular orientation in space during or after their manufacture.

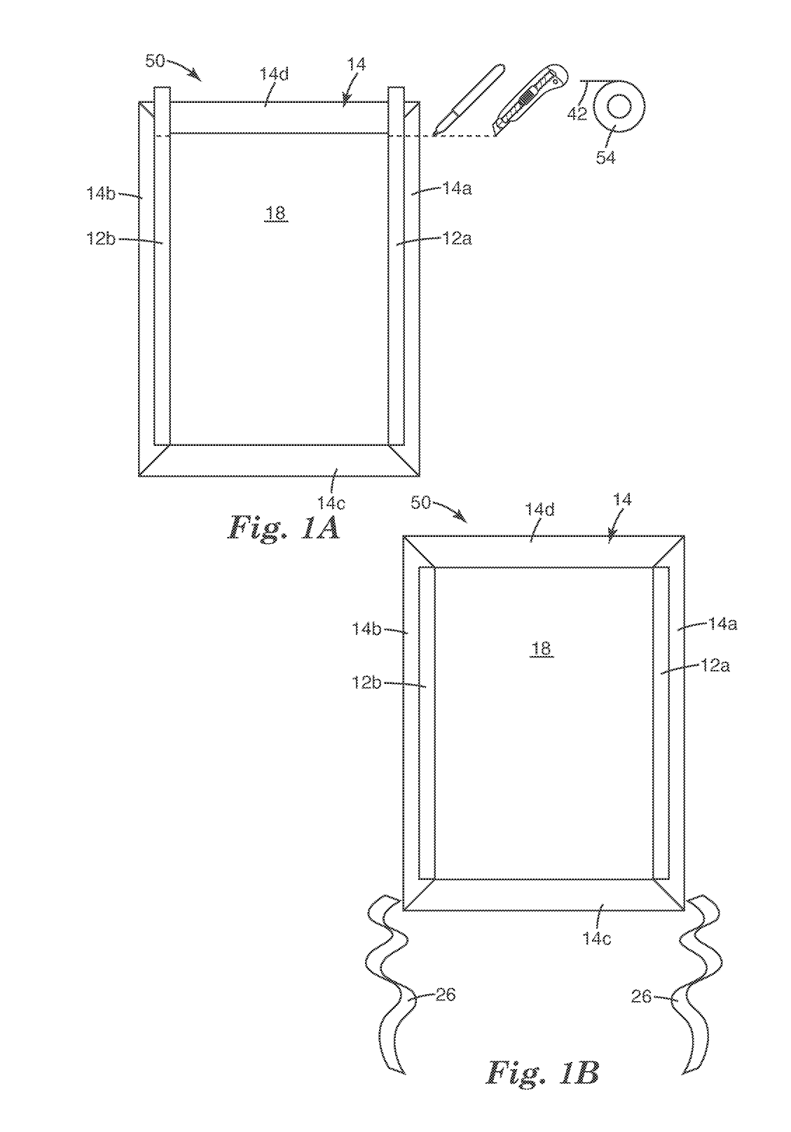

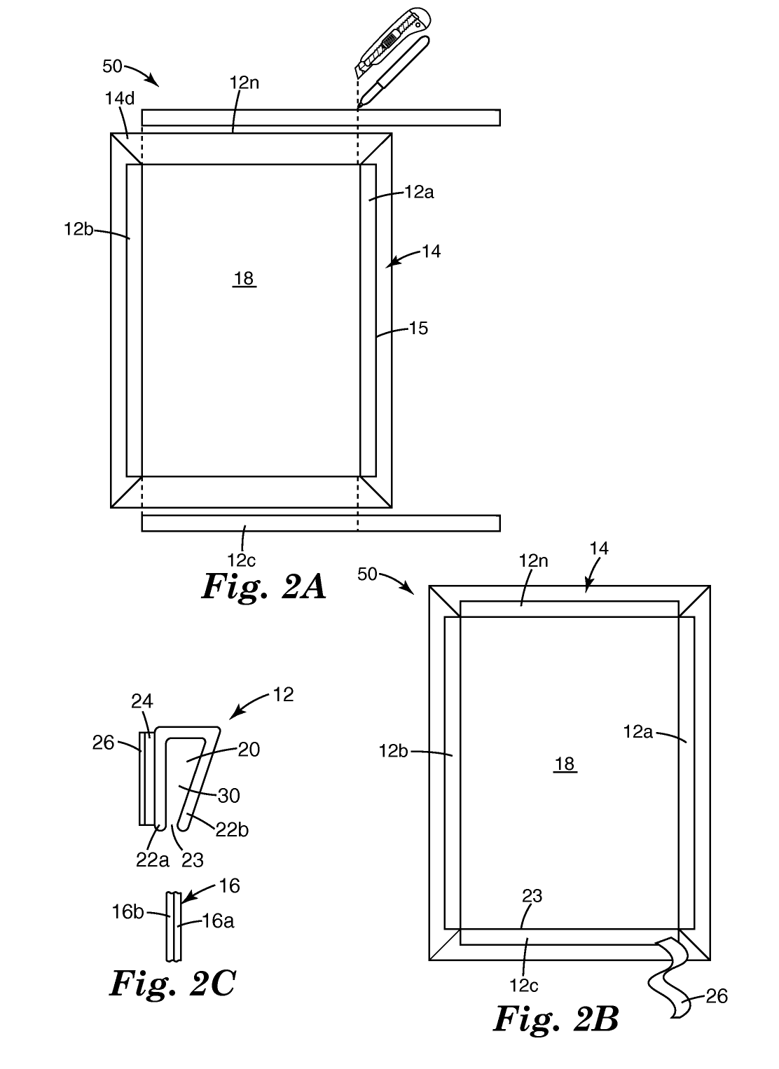

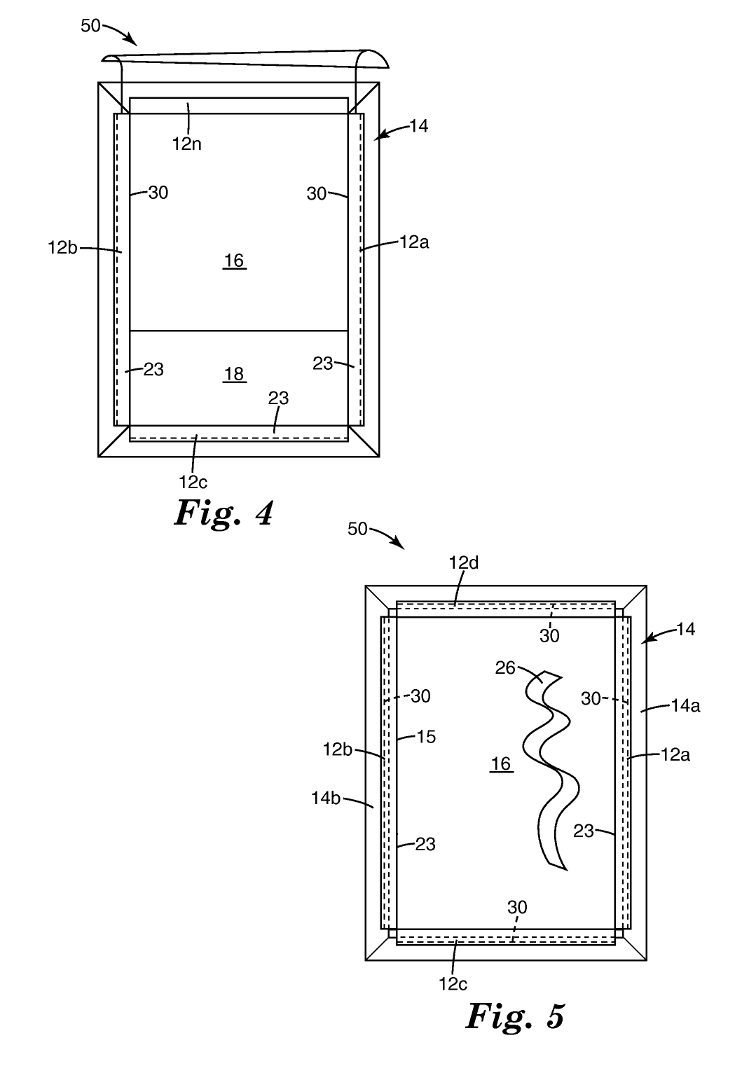

Reference is made to FIGS. 1A-8 for illustrating the making, installing, and using of a modular frame assembly 10 (FIG. 7) made according to one aspect of this invention. As seen in FIGS. 1A-2B there are illustrated a plurality of frame segments or elements 12ₐ₋ₙ (collectively, 12). As will be described, the frame elements 12 are utilized for forming the modular frame assembly 10 that is particularly adapted to be mountable on window assembly 14. The modular frame assembly 10 has a frame opening 15 (FIG. 5) over which is adapted to have in close fitting relationship, a window film sheet structure 16 (see, FIG. 4) in spaced apart relationship to an underlying window 18 of the window assembly 14. The window 18 may made of a wide variety of suitable materials, such as glass, plastic, etc. Alternatively, the modular frame assembly 10 can be utilized independently without a window in the window assembly 14. In the illustrated embodiment, the window assembly 14 is a residential type. However, the present invention is not limited to such a window system since other suitable systems and frames, such as for doors, panels and the like are envisioned.

One cross-sectional view of a frame element 12 is shown in FIG. 2C. Each of the frame elements is elongated and has a generally U-shaped channel 20 extending along its length. The channel 20 is defined by slightly flexible channel wall portions 22a, 22b running along its longitudinal extent. The frame elements 12 may be made of a suitable molded plastic, metal or the like, whereby the channel wall portions 22a, 22b tend to converge at their distal ends, as illustrated, to define an open slotted end 23 adaptable to slidably receive therebetween, edges of the window film sheet structure 16. The channel wall portions 22a, 22b are adapted to resiliently retain the window film sheet structure 16 in close fitting relationship therewith, whereby the window film sheet structure 16 will be spaced from the underlying window 18. In one embodiment, the frame elements 12 may have one or more stripes of double-sided pressure-sensitive adhesive tape 24 adhered to a side that is to engage the window frame assembly 14. The pressure-sensitive adhesive tape 24 is provided with a low-adhesion release liner 26. In FIG. 1B, after the release liner 26 is removed, each of the vertical frame elements 12a, 12b is pressed against and mounted to opposed and parallel vertical frame portions 14a, 14b of the window assembly 14, such as illustrated in FIG. 1B. Instead of double-sided adhesive tape, single-sided adhesive tape may be utilized. Alternatively and/or additionally, the frame elements 12 may be mounted to the window assembly by other attachment mechanisms, such as hook and loop mechanisms cling type mechanisms, suction mechanisms, and other kinds of suitable adhesives systems are envisioned including acrylic type adhesives. The frame elements 12 are mounted so that their open-sides 23 are aligned with each other and are generally parallel to each other.

As illustrated in FIGS. 2A-2B, horizontal frame elements 12c and 12n are measured and cut by a suitable cutting tool after being placed on the horizontal frame portions 14c (FIG. 1A), 14d. The horizontal frame elements 12c and 12n are measured and cut, as illustrated. After, the release liners 26 thereof are removed, their respective open sides 23 are aligned with open sides 23 of the frame elements 12a and 12b. In this embodiment, the open sides of the bottom frame members generally extend between the open sides of the vertical frame elements. Accordingly, they define a slot-like and generally U-shaped receptacle 30 (FIGS. 4 & 5) for removably receiving the window film sheet structure 16. Hence, the window film sheet structure 16 may be received and held by each of the frame elements 12_{a-c}. It is noted that at this point in the installation the top frame element 12n has not been mounted. This frame element 12n will be positioned after the window film sheet structure 16 is slid into the receptacle 30, such as shown in FIG. 4, to thereby enclose the window film sheet structure 16 within the receptacle.

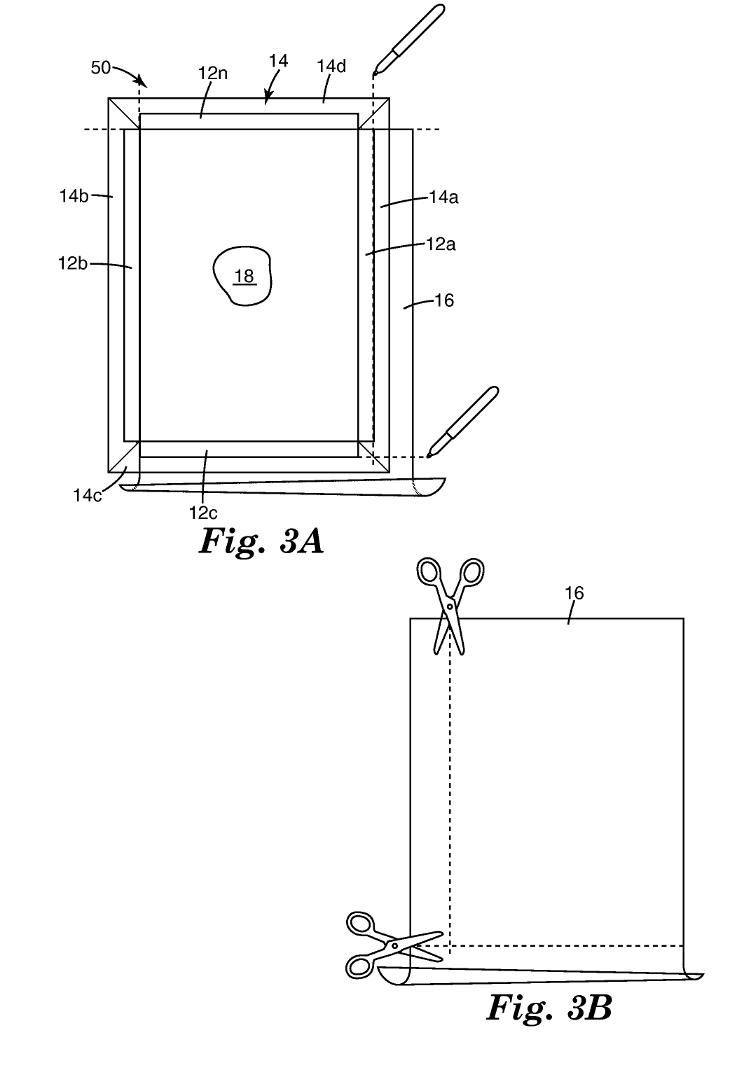

Referring to FIGS. 3A and 3B, the window film sheet structure 16 is placed over the modular frame assembly and measured to the outside vertical and horizontal edges of the frame elements 12. As illustrated in FIG. 3B, the window film sheet structure 16 is cut as by scissors or the like so that it has proper dimensions to fit within the receptacle 30 (FIGS. 4 & 5) and hence cover the underlying window 18.

In FIG. 5, the frame element 12n is positioned so that it fits over and is in an interfitting relationship with a top edge of the window film sheet structure 16, whereby the window film sheet structure is entirely enclosed by the frame elements 12. Of course, prior to this step, its release liner 26 associated with the pressure-sensitive adhesive on the frame element 12n is removed.

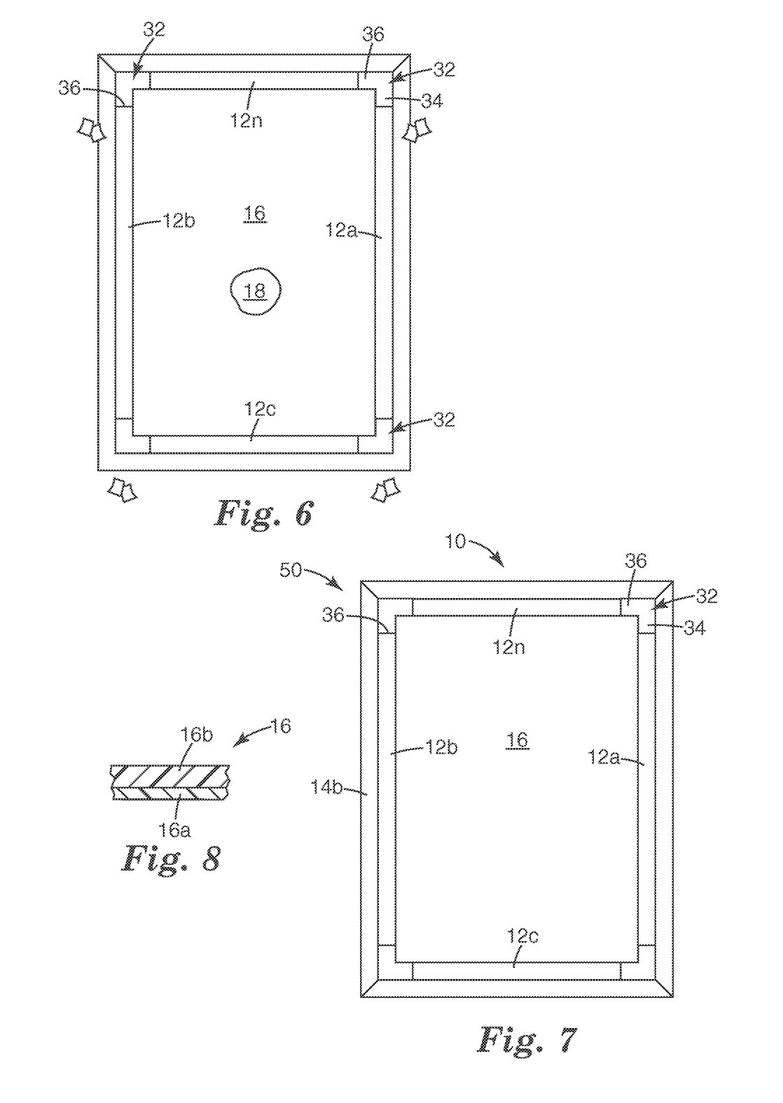

Referring to FIG. 6, a plurality of finishing corner connector members 32 are mounted on the window assembly. In this embodiment, they are positioned at the corner intersections of the frame elements 12ₐ₋ₙ. The corner connector members 32 also have a double-sided adhesive tape 24 (FIG. 2C) on one side thereof that is to engage the window frame assembly 14. Prior to being mounted, the corner connector members 32 have their release liners 26 removed. The tape 24 engages the window assembly 14. In one embodiment, the corner connector members 32 have exposed surfaces 34 with an appearance that generally matches the appearance of the frame elements 12. The corner connector members 32 have overhanging flange portions 36 adaptable to snuggly overlie the frame elements. Although not shown, the overhanging flange portions 36 may have a contour that matches the contours of the outside surface of the frame elements 12. Within the scope of the present invention, the corner connector members 32 may have other configurations and appearances. They assist in providing the modular frame assembly with a unified appearance for aesthetic purposes.

Reference is made to FIG. 8, for illustrating one embodiment of the window film sheet structure 16. The window film sheet structure 16 may be a transparent plastic material that is flexible and yet has sufficient stiffness so that it can retain its dimensions and shape when mounted. In addition, the window film sheet structure 16 is to have its major exterior surfaces without an adhesive layer. There are a number of approaches for attaining such constructions within the spirit and scope of this invention.

In one illustrated embodiment, the window film sheet structure 16 is a window film structure that includes a removable clear liner 16a joined to a film base structure 16b through a pressure-sensitive adhesive layer (not shown). While the window film sheet structure 16 noted typically has its clear liner removed, this invention envisions not removing such so as to impart stiffness. In this manner, the window film sheet structure 16 will retain its planar relationship and avoid being too flimsy and creasing so as to cause permanent flaws therein. Instead of removing the clear liner 16a, it will remain with the base structure 16b. Accordingly, the film will have a thickness in a range that will provide the requisite stiffness. This window film sheet structure 16 may be of the solar window film type. The clear liner 16a can be made of polyester, vinyl, or suitable material, the film base structure 16b can be made of a suitable polypropylene or polyethylene material. Other suitable materials polymer sheet materials may be used. Whatever materials are used the collective thicknesses should be sufficiently thick for the window film sheet structure 16 to be flexible and yet stiff enough to hold its dimensions during use. One commercial version of such a film structure is Prestige™ that is commercially available from 3M Company, St. Paul, Minn. This film has a base structure that includes a polyester material having an adhesive thereon, and a clear liner made of polyester. Another example of a window film sheet structure that may be used, is Scotch® Tint film that is commercially available from 3M Company, St. Paul, Minn. The thickness of such window film structures may be in the range of about 2 mil to about 10 mil.

Another embodiment contemplates using a window film structure with an additional transparent layer that is added to a window film structure that may be too thin to provide stiffness of the kind described herein. In this regard, the additional layer serves to increase thickness of the window film sheet structure so that the latter will obtain desired stiffness. The additional layer may be co-extruded with the window film base structure. The additional layer is essentially added to provide stiffness to the overall window film sheet structure. In this manner, the window film sheet structure will tend to retain its dimensions and planarity, such as when mounted to the film frame. The additional layer is not intended to add optical properties that affect the functioning of the window film sheet structure. Alternatively, additional layers may have materials added thereto, in any suitable manner, so as to alter the optical properties of the overall window film sheet structure.

The window film sheet structures may be selected from a group of window film structures that comprises solar window film, privacy window film, anti-graffiti film, security window film, graphic design film, frosted finish film or any combination thereof. The foregoing films may reflect ultraviolet and infrared solar energy as well as possess other known characteristics.

Provision is made for a kit 50 (see FIGS. 1A, 2A-3A, 4, 5 & 7) containing components that facilitate an installer being able to customize a modular frame assembly 10 to a window assembly 18 having a wide variety of shapes and sizes. This kit 50 is particularly adapted to be utilized in the context of a do-it-yourself environment because of the ease and reliability of using it. In this regard, the kit 50 provides at least a sheet of the window film sheet structure 16; a roll 54 (FIG. 1A) of pressure-sensitive adhesive tape 24 that is applicable for suitably joining the frame elements to the window assembly. In FIG. 1A, the kit 50 includes a set of four frame elements 12. In FIGS. 6 & 7 the kit 50 as well as a plurality of frame corner connector members 32, as well as a set of instructions (not shown).

FIG. 7 illustrates a modular frame assembly 10 that has been assembled according to one aspect of a method of the present invention.

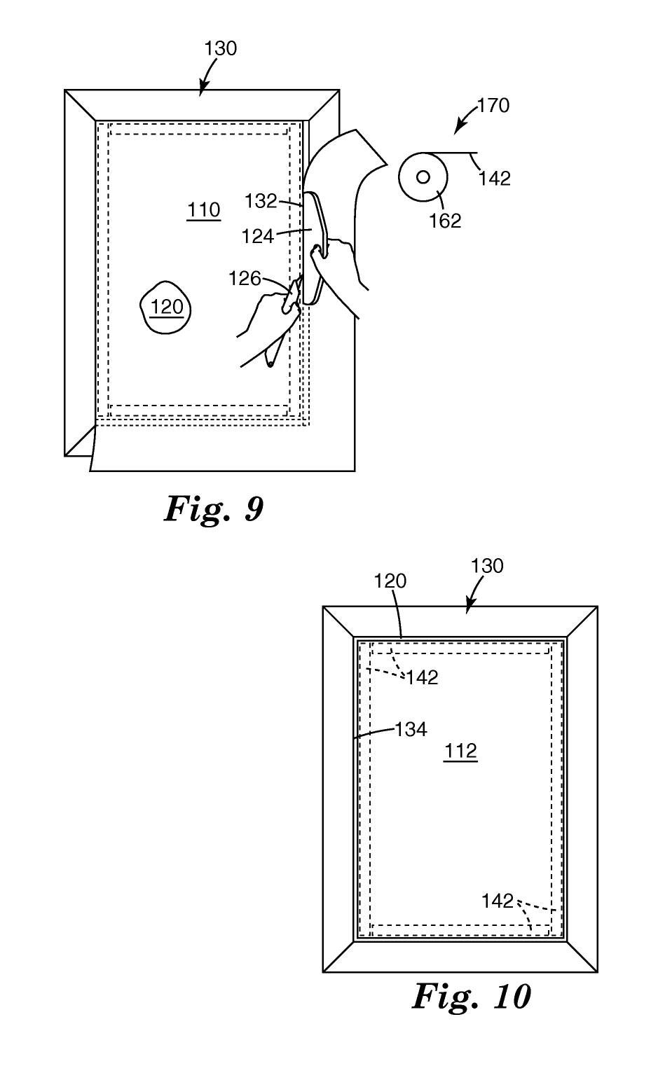

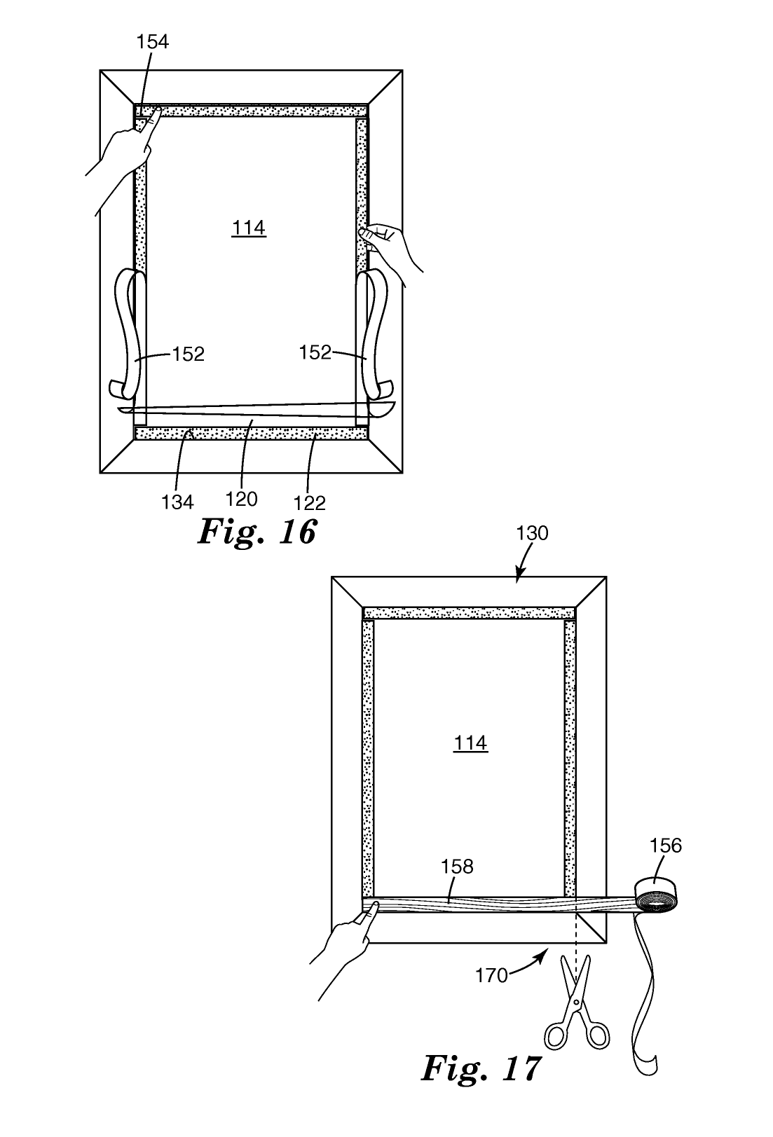

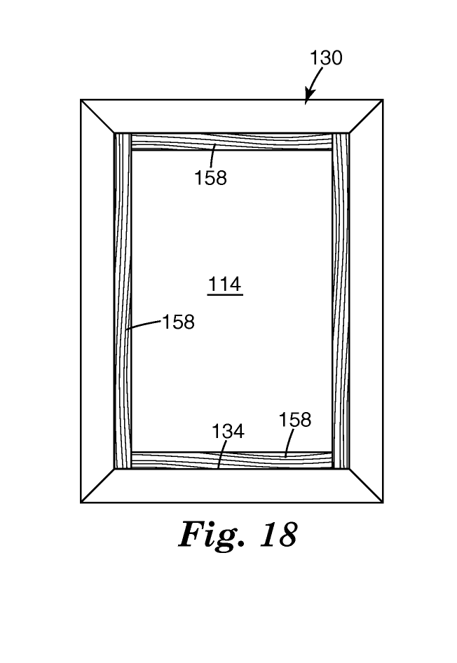

Reference is made to FIGS. 9-18 for illustrating another embodiment of the present invention that is directed to properly spacing a window film sheet structure in spaced apart and juxtaposed relationship to an underlying window assembly. This embodiment differs from the preceding one in that the window film sheet structure 114 (FIG. 16) is spaced from the window 120 by elongated spacer elements 122 that are mounted on the window or transparent panel itself.

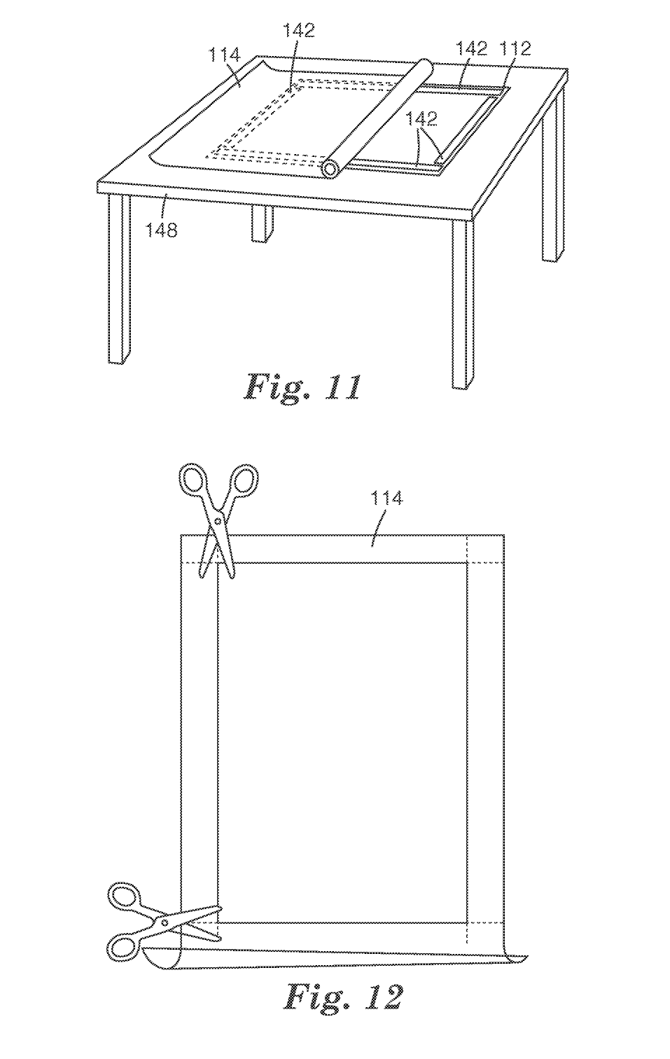

FIG. 9 is a schematic view of a working tool template blank or template blank sheet 110. Details of the construction of the working tool template blank sheet 110 and the film mounting tool apparatus 112 (FIG. 10) are described in detail in the noted commonly-assigned and copending U.S. patent application Ser. No. 11/618,050 and which is incorporated herein as a part hereof. The use in this application is different from that described in the noted patent application in that it is not used as a mounting tool apparatus for directly mounting a laminate on the window. Accordingly, only those aspects thereof that are useful in describing the invention in the present application are set forth. The template blank sheet 110 is for properly sizing and shaping the window film sheet structure 114 (FIGS. 11 & 12). In FIG. 11, the window film sheet structure 114 has yet to be cut and mounted on a transparent panel 120 (FIG. 9), such as a window 120 (FIG. 9).

Reference is made back to the window 120. As noted, it is one of many kinds of substrates that can be laminated according to one aspect of this invention. The window 120 may be any type made of any suitable material, such as glass, transparent plastics or the like. Additionally, the window 120 can have any number of suitable optical, chemical and mechanical properties. The window 120 is surrounded by a suitable window assembly 130, such as the kind utilized for residential purposes. It will be appreciated that there exists a wide variety of window assemblies that may be utilized and the type depicted is for illustration purposes only.

As seen in FIG. 9, the template blank sheet 110 may be oversized relative to the window 120 prior to being cut. The template blank sheet 110 may be made of a thin, flexible and pliable material capable of being flexed or bent without tearing or breaking. It may be creased easily as at 132 along edges formed by a spacer tool 124. Creases 132 serve to guide the installer while cutting. The crease(s) 132 also define the geometric shape of the working tool apparatus 112 to be formed.

The materials selected for the template blank sheet 110 may be durable to allow reuse. The installer can cut along or adjacent the creases 132 to thereby enable accurate sizing and shaping functions to be carried out. The template blank sheet 110 may be comprised of one or more layers of a pliable material selected from a group consisting of but not limited to paper, non-woven materials, and suitable sheet polymers. The template blank sheet 110 may have any suitable thickness. Thickness ranges are typically about 5 to 10 mils, but may exceed such range depending on the material being used. The foregoing materials and/or thicknesses are selected so that the template blank sheet 110, when formed into the mounting tool apparatus 112 (FIG. 10), is relatively stiffer than the window film sheet structure 114 to be installed.

In FIG. 9, a spacer tool 124 has a preselected thickness and creases or folds the template blank sheet against portions of the window assembly 130. A cutting tool 126 can then be utilized to cut the template blank sheet 110 adjacent the spacer tool 124. The spacer tool 124 in this embodiment has a thickness to insure that there is a margin of clearance surrounding the mounting tool apparatus 112.

An installer can first attach the double-sided pressure sensitive adhesive stripes 142, unrolled from a web roll 162 (FIG. 9) supplied in the kit 170, to the template blank sheet 110 for example, after the latter has been unrolled from a web roll (not shown) supplied in the kit 170. The adhesive stripe release sheets have been removed from adhesive layers 146 prior to the adhesive stripe being utilized. Suitable double-sided pressure sensitive adhesive tapes, such as the transfer tapes available under the trade designations “SCOTCH #9416” or “SCOTCH #9415” from 3M Company (St. Paul, Minn.) may be utilized. Other suitable pressure sensitive adhesives may be used. While the adhesive articles or stripes 142 are described in spaced apart locations on the template blank sheet 110, such as along the edges, the stripes 142 may be placed at other locations as well. Other suitable kinds of adhesives are envisioned. Also, different kinds of stripes or dot patterns of adhesives can be used in any desired pattern.

The window film sheet structure 114 is utilized for changing the optical properties of the underlying window 120 as well as may potentially increase an R-value of the window assembly. The window film sheet structure 114 can be the same as described in the preceding illustrated embodiment. The illustrated embodiment may use the window film sheet structure 114 as described above in FIG. 8.

Reference is now made to FIG. 11, wherein the film mounting tool apparatus 112, formed as noted, is mounted flat on a table 148 or other like supporting surface. An oversized window film sheet structure 114 is unrolled from a roll and directly mounted on the film mounting tool apparatus 112 through the adhesive strips 142. As such, an installer can more easily and reliably cut and trim the perimeter of the window film sheet structure 114, such as by using scissors or the like (see FIG. 12), thereby matching the size and shape of film mounting tool apparatus 112. The film mounting tool apparatus 112 acts as a template. Because of the noted adhesive contact, the window film sheet structure 114 and the mounting tool apparatus 112 remain together without movement to insure accuracy in cutting. As a result, there is provided a high degree of assurance that its size and shape will match that of the mounting tool apparatus.

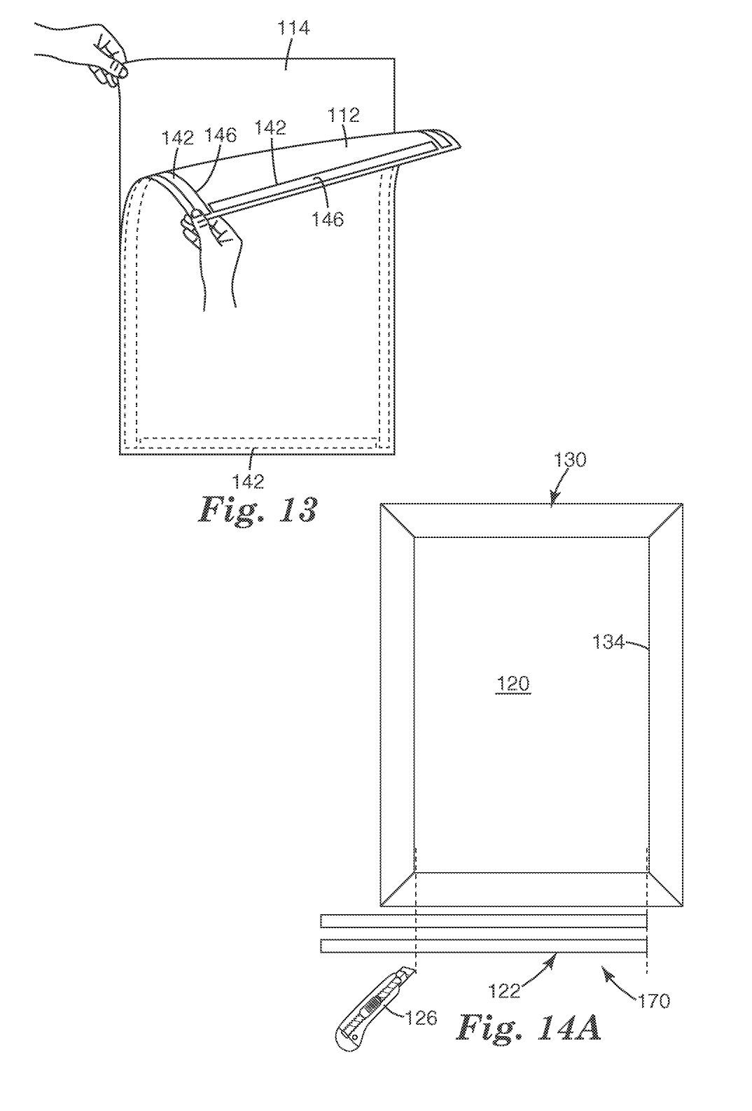

Reference is now made to FIG. 13, wherein prior to mounting the cut window film sheet structure 114 is delaminated from the working tool template apparatus 112. Delaminating is achieved by an installer grabbing corners of both sheets and peeling them apart.

Prior to installing the window film sheet structure 114, the present invention contemplates use of elongated spacer elements 122 made of any suitable material, such as molded plastic. The spacer elements 122 are thin and elongated stripes which form a frame assembly 145 (FIG. 15) for the film sheet structure 120 to be mounted on. Opposing sides of the spacer elements 122 have stripes of double-coated pressure-sensitive adhesive stripes 149 thereon. In other words, the thickness of spacer elements 122 determines the distance the window film sheet structure 120 is spaced relative to the window. Also, the pressure sensitive adhesive stripes 149 may be single-sided. In this latter regard, a substrate of the single-sided type may be permanently affixed to the spacer elements.

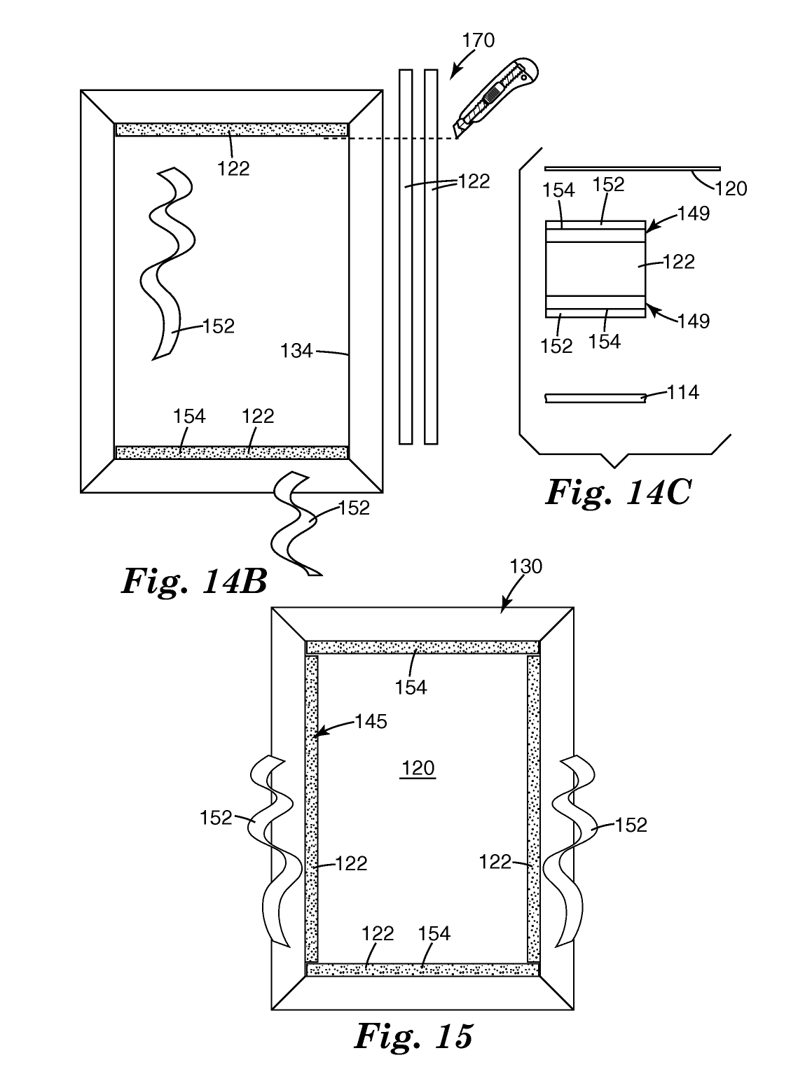

As shown in FIGS. 14A and 14B, the spacer elements 122 are measured and cut so as fit within the opening 134. In FIG. 14B the pressure-sensitive adhesive stripes have their release liners removed and then are pressed into engagement with the window as illustrated. FIG. 14C is a schematic view illustrating a spacer element according to this invention in a spaced relationship with a window and a window film sheet structure. A spacer element 122 is depicted so that it has pressure-sensitive adhesive stripes 149 on opposing facing sides. Each one of which is to face a corresponding one of the window film sheet 114 and the window 120. Each of the pressure-sensitive adhesive stripes 149 includes a release liner 152 which when removed exposes a surface of an adhesive layer 154. One of the adhesive stripes is to engage the window and the other to engage the window film sheet structure 114. FIG. 15 shows all the spacer elements 122 mounted on the window within the confines of its opening. As seen in FIG. 16, release liners 152 have been removed from the opposite ends of the spacer elements, thereby exposing their adhesive layers 154. The cut window film sheet structure 114 is then mounted to the adhesive layers 154 as seen in FIG. 16. Because of the nature of the window film sheet structure 114, as noted, it will remain in a generally planar position across the frame opening. As seen in FIGS. 17 & 18, a roll 156 of wood grain trim tape 158 is applied to cover spacer elements 122 so as to finish the window, whereby the appearances of the tape and window assembly may generally match. Other types of finishing tapes may be used in this regard.

To implement the foregoing a kit 170 is provided that includes: template blank or sheet 110, window film sheet structure 114, spacer elements 122, a cutting tool 126, adhesive stripes 142, 149, a roll 156 of wood grained finishing tape 158, and a set of appropriate instructions (not shown).

The window film sheet structure is used for changing the optical properties of the underlying window. Window film sheet structures are generally transparent plastic and/or metallized film sheet structures that are applied as thin layers to transparent panels, such as glass windows. Window film sheet structures are available in many different compositions for bringing about varying effects on the optical and mechanical properties of the underlying transparent panels. The present invention is not limited by the kind of window film sheet structure to be used.

The above embodiments have been described as being accomplished in a particular sequence. It will be appreciated that such sequences of the operations may change and still remain within the scope of the invention. Also, other procedures may be added.

One aspect of this invention may take on various modifications and alterations without departing from the spirit and scope. Accordingly, one aspect of this invention is not limited to the above-described embodiments, but is to be controlled by limitations set forth in the following claims and any equivalents thereof.

One aspect of this invention also may be suitably practiced in the absence of any element not specifically disclosed herein. All patents and publications noted above, including any in the Background section are incorporated by reference into this document in total.

I claim:

1. A method of installing a film sheet structure in spaced apart relationship to a transparent panel, the method comprises: providing a frame that includes a plurality of frame elements for defining a frame opening; providing a film sheet structure that is sized to cover the frame opening; adhesively securing one side of each of the frame elements to the transparent panel; and adhesively securing another side of each of the frame elements to the film sheet structure so that the film sheet structure is in spaced apart and thermal insulating relationship to the transparent panel.

2. The method of claim 1, wherein the providing a film sheet structure is performed by preliminarily generating a mounting tool by cutting a blank sheet to generally match the size and shape of the transparent panel; joining mutually opposing major surfaces of the film sheet structure to the mounting tool so that both are in a generally juxtaposed and coextensive relationship with each other; cutting the film sheet structure so that its shape and size generally conforms to that of the mounting tool; and delaminating the shaped and sized film sheet structure from the working tool.

3. The method of claim 2, wherein the joining uses pressure-sensitive adhesive portions.

4. The method of claim 3, wherein the delaminating is performed by peeling the pressure-sensitive adhesively secured working tool and film sheet structure.

5. An assembly comprising:
a transparent panel;
a frame that includes a plurality of frame elements for defining a frame opening, one side of each of the frame elements adhesively secured to the transparent panel; and
a film sheet structure sized to cover the frame opening, the film sheet structure adhesively secured to another side of each of the frame elements such that the film sheet structure is in spaced apart and thermal insulating relationship to the transparent panel.

6. The assembly of claim 5, wherein the one side of each of the frame elements is adhesively secured to the transparent panel using pressure sensitive adhesive portions.

7. The assembly of claim 5, wherein the another side of each of the frame elements is adhesively secured to the film sheet structure using pressure sensitive adhesive portions.

8. The assembly of claim 5, wherein the film sheet structure includes non-adhesive exterior major surfaces.

9. The assembly of claim 5, wherein the film sheet structure is selected from a group that comprises solar window film, privacy window film, anti-graffiti window film, security window film, graphic design window film, frosted finish window film, and any combination thereof.

10. The assembly of claim 5, wherein the film sheet structure has a thickness of about 2 mil to about 10 mil.

11. The assembly of claim 5, wherein the transparent panel is a window.

12. A kit comprising:
a plurality of frame elements for defining a frame opening;
a film sheet structure; and
a plurality of adhesive portions attachable for adhesively securing the frame elements to the window, and for adhesively securing the window film sheet structure to the frame elements.

13. The kit of claim 12, wherein the adhesive portions comprise pressure sensitive adhesive portions.
